(19) United States
(12) Patent Application Publication
(10) Pub. No.: US 2013/0291482 A1
(43) Pub. Date: Nov. 7, 2013

(54) MODULAR COLUMNS FOR CONSTRUCTION PURPOSES AND METHOD FOR THE PRODUCTION THEREOF

(71) Applicant: Jose Santos Limon Cornejo, Zapopan (MX)

(72) Inventor: Jose Santos Limon Cornejo, Zapopan (MX)

(73) Assignee: TIS & PARTNERS CO., LTD., TOKYO (JP)

(21) Appl. No.: 13/882,774

(22) PCT Filed: Nov. 12, 2010
(86) PCT No.: PCT/MX10/00129

§ 371 Date: Jul. 21, 2013

(30) Foreign Application Priority Data
Nov. 2, 2010 (JP) 2010-246862
Oct. 17, 2011 (JP) PCT/JP2011/005782

(51) Int. Cl. E04C 3/36; B28B 1/08

(52) U.S. Cl. CPC E04C 3/36; B28B 1/08
USPC 52/848; 264/72

(57) ABSTRACT

The present invention relates to modular columns for construction purposes, which comprise: a metal profile section positioned vertically, functioning as a post that may optionally be anchored to or fixed to the surface of the floor; a series of base modules, “body” and capital, which in turn are formed from two symmetric blocks which have a recess, resulting in a square hollow that is filled with a conventional mixture of cement, river sand and lime, which, once dried, holds the blocks firmly joined to the profile section. The invention furthermore provides a method for the production of the modular columns and also a procedure for the installation thereof, with alternatives for columns that are load-bearing or that are simply for aesthetic purposes, said methodologies involving a series of practical, easy-to-follow steps.

### CROSS-REFERENCE TO RELATED APPLICATIONS

This application is a Submission Under 35 U.S.C. §371 for U.S. National Stage Patent Application of International Application Number PCT/MX2010/000129, filed Nov. 12, 2010, and entitled MODULAR COLUMNS FOR CONSTRUCTION PURPOSES AND METHOD FOR THE PRODUCTION THEREOF, the entirety of both are incorporated herein by reference.

### TECHNICAL FIELD

The present invention involves the fields of mechanics and chemistry, and more specifically those methods used in the area of construction to produce columns designed to bear loads or simply as aids in the formation of highly aesthetic structures.

### OBJECT OF THE INVENTION

To provide a methodology for the manufacture and erection of columns on the basis of modules which simplify and facilitate the construction thereof. A further object of the invention is to provide modular columns that are manufactured using a special mixture that renders them easy to work with but are strong and durable, since they are intended to bear the load of vaults or floors.

### BACKGROUND

In Mexico, the technique that has been used for several years for making a column consists of placing a vertical rebar column [castillo] within a cardboard cylinder, which is used as a container into which the mixture (cement, gravel, river sand and water) is poured, upon which this mixture is poked with a rebar rod in order ensure that air bubbles are formed on the interior of the cardboard container, and then this is allowed to stand for at least 48 hours until the mixture hardens and, once hard, the cardboard cylinder can be removed in order to then wet the newly formed column with water to set it. Unfortunately, this method has considerable drawbacks: For one, the cardboard cylinder has to be firmly held in its position by means of posts; for another, once it is in place, it is necessary to pour the mixture through the upper end of the cardboard cylinder, for which purpose it is necessary to carry the mixture and pour it inside the cardboard, which causes it to spill over the dirtied surface and get the surroundings wet. One more practical way to produce a column is by means of building blocks that are placed one directly on top of the other until the desired height is reached.

On the other hand, there exists technology in the prior art such as that developed in U.S. Pat. No. 7,641,178 B1, which describes a system of blocks configured to be compatible with a structure of columns in construction. Each block has four faces and each of the faces can have the same dimensions. The width of the block can generally be twice the height, and the faces of the block also contain a groove for adding to the aesthetic appearance of the column. The blocks have certain presentations for construction, which include brackets that hold a panel wall. The blocks have elements that connect them to one another or projections that enable a positive connection between them. The projection of one block extends within the core of another block. Adjacent blocks can be rotated 90 degrees in relation to the vertical axis of each block. These blocks can be utilized to construct a column that is easy to install and provides good structural conditions. The drawback of this type of column lies in the fact that they are not designed to bear loads, merely serving to construct fences.

### DETAILED DESCRIPTION OF THE INVENTION

The characteristic features of these novel modular columns for construction purposes and method for the production thereof are demonstrated clearly in the following description and in the accompanying figures, which are mentioned for the sake of example and must not be considered as limiting the present invention.

### BRIEF DESCRIPTION OF THE FIGURES

FIG. 1 is a front view of a modular column with sectional blocks.

FIG. 2 shows a perspective view of a module of sectional blocks.

FIG. 3 is a perspective view of a symmetrical sectional block.

FIG. 4 is a top view that is substantially the same as the bottom view of the sectional module.

FIG. 5 is a side view of the sectional block.

FIG. 6 shows a front view of the sectional block.

FIG. 7 is a front view of a modular column with pentagonal blocks.

FIG. 8 shows a perspective view of a module of pentagonal blocks.

FIG. 9 is a perspective view of a symmetrical pentagonal block.

FIG. 10 is a top view that is substantially the same as the bottom view of the module with pentagonal blocks.

FIG. 11 is a side view of the module with pentagonal blocks.

FIG. 12 shows a front view of the module with pentagonal blocks.

FIG. 13 is a front view of a modular column with blocks with triangular recess.

FIG. 14 shows a perspective view of a module of blocks with triangular recess.

FIG. 15 is a perspective view of a symmetrical block with triangular recess.

FIG. 16 is a top view that is substantially the same as the bottom view of the module with blocks with triangular recess.

FIG. 17 shows a front view of the module with blocks with triangular recess.

FIG. 18 is a conventional perspective view of the module of “horn” blocks.

FIG. 19 is a perspective view of the symmetrical “horn” block.

FIG. 20 shows a top view of the module of “horn” blocks.

FIG. 21 is a front view of the module of “horn” blocks.

FIG. 22 is a schematic view of a modular column anchored to the ground.

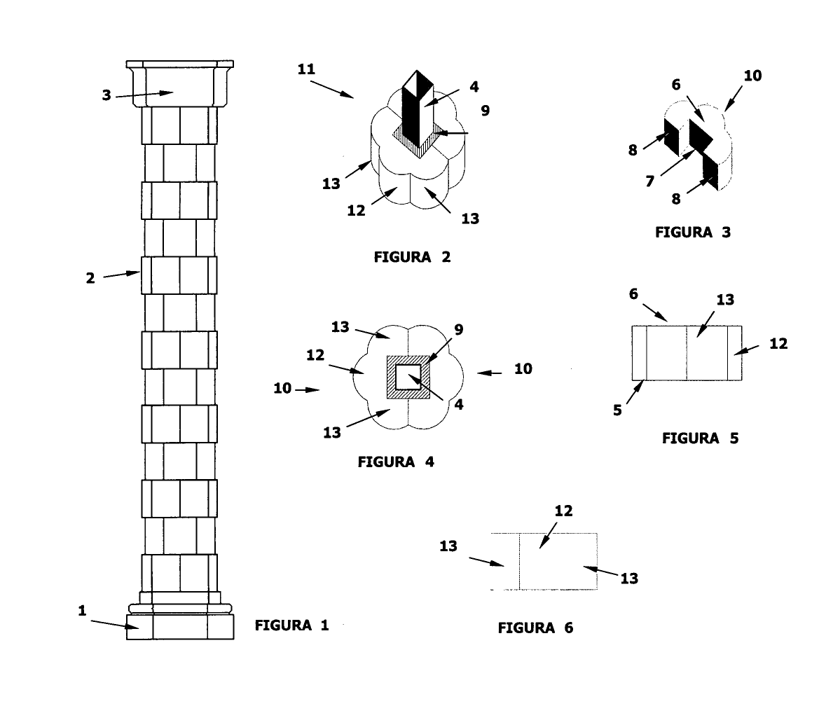

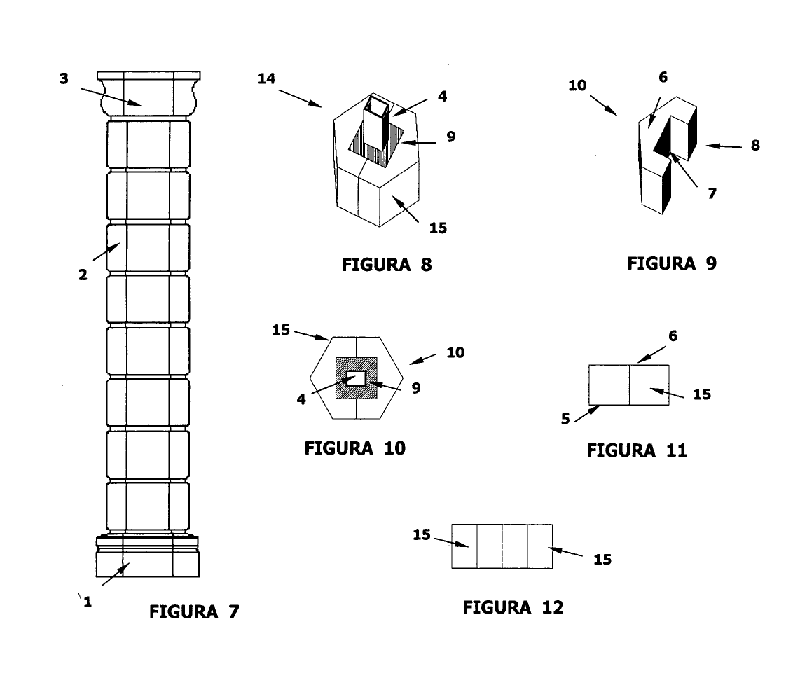

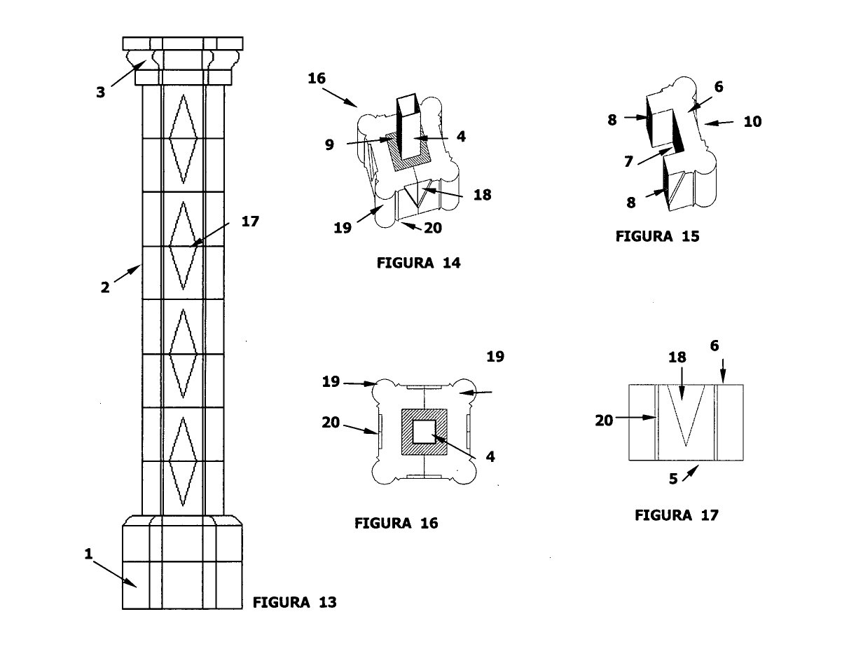

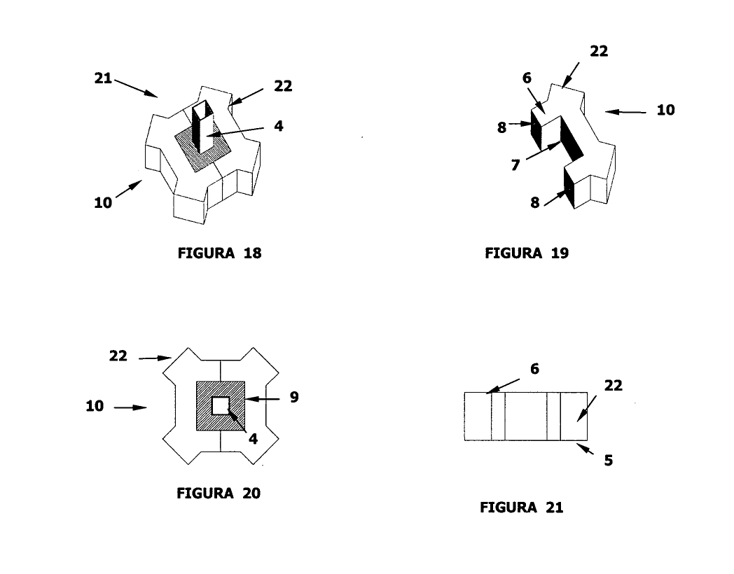

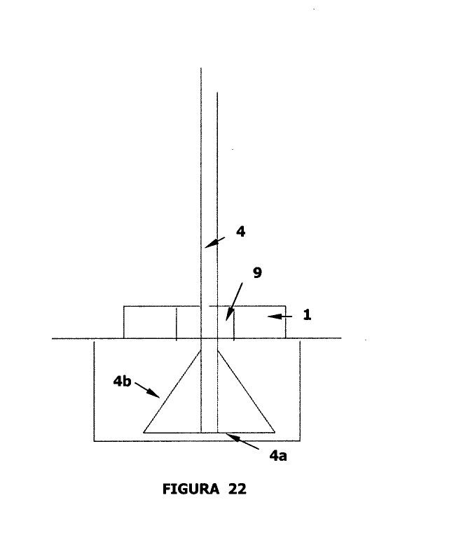

With reference to said figures, the columns for construction are comprised of:
a) a base module (1) which, when it makes contact with the horizontal that forms the ground, bears on it all of the weight of the modular column;
b) a number of “body” modules (2) which are placed one on top of the other in overlapping fashion until the height of the column is established when the last “body” block is placed on top;
c) a capital module (3) which is located at the upper end of the body of the column, it being possible for said capital block to bear weight or not if it is a modular column merely for aesthetic purposes;
d) a PTR profile (4) which is placed perpendicular to the ground, the lower end of the profile having welded in a perpendicular position a metallic grate (4a) and reinforcements (4b) made of rebar which are positioned in an inclined manner from the metallic grate to the PTR body and are used to reinforce the anchoring of the modular column from its base, as can be seen in FIG. 22; and
e) a mixture of materials, described further below, which is used to join the symmetrical blocks to the vertical PTR profile.

All of the modules are optionally constructed from various regular and irregular prismatic bodies, it also being important to emphasize that each module is comprised of two symmetrical blocks, each of them having:
i) two flat horizontal faces, one lower (5) and one upper (6), the first making contact with the surface of the ground and second serving as a platform so that the lower face of the first of the series of modules can rest on same, and the upper faces are placed successively on the lower faces to form the “body” and cap of the modular column;
ii) a vertical flat face which has located in its center a rectangular recess (7) which results in the formation of two smaller vertical flat faces (8) used to make contact with the two respective vertical flat faces of the symmetrical block, thus forming a module. On the other hand, the rectangular recesses of each block and its symmetry form a square hollow (9) that is filled with mixture which, once solid, joins them; in addition, the PTR profile (4) is introduced in a vertical position in the center of said square hollow;
iii) at least one design face (10) which is also considered to be the front face of each symmetrical block, said face being able to adopt various geometrical shapes of regular and irregular polygons, in addition to which semiprecious stones can optionally be adhered to the surface or surfaces that are formed on the design face, or predetermined images can be engraved on same.

The present invention also proposes a series of symmetrical blocks of the “body” type to make different columnar designs, which are described below:
i) “sectional” type blocks (11) whose design face (10) has three semi-cylindrical projections, one central (12) and two lateral projections (13), which are perpendicular to the horizontal flat faces, where each one of the two latter ones meets at each end of its vertical flat face (8);
ii) pentagonal blocks (14) which, once joined, form hexagonal modules as shown in FIG. 8. Each design face of these blocks has two inclined flat surfaces (15) which form four of the faces of the hexagonal module, since, once the lateral faces of each symmetrical block are joined, they form the two remaining faces to form said hexagonal module;
iii) blocks with triangular recess (16) for forming square modules which, when combined, form a vertical row of diamonds (17); for this purpose, the modules are placed such that the bases of the triangular recesses (18) are made to coincide. The design face of these blocks has cylindrical bodies (19) integrated into it which have a V-shaped recess (20) on each side which, once in the column, appear as a pair of grooves that run the length of the body of the column.

Moreover, “horn”-type blocks (21) are included for the column base whose design face has square corners (22).

The method for manufacturing the modular columns for construction is characterized by comprising the following steps:
1.—Weigh the following series of materials to prepare 100 kg of a mixture that, once solid, aesthetically imitates stone; for this purpose, the following components must be poured into a conventional mixer:

| No. | Material | (%) | Tolerance (%) |
|---|---|---|---|
| i) | Clay | 30 | ±3 |
| ii) | River sand | 20 | ±8 |
| iii) | Pumice gravel [jal] | 30 | ±10 |
| iv) | Red volcanic rock [tezontle] | 10 | ±12 |
| v) | Pigment | 3 | ±10 |
| vi) | Talc | 5 | ±3 |
| vii) | Siamil slurry | 2 | ±3 |

2.—Dry-mix the mixture from the previous step in a mixer for 2 to 3 minutes at 60 ram until a homogeneous mixture is obtained.
3.—Add to the moving mixture the equivalent of 33% of the total mixture of gray cement and continue to mix for 1.5 minutes at 60 rpm to homogenize.
4.—Add 3 to 9 liters of water to the total mixture for the purpose of moistening it and continue mixing for 3 minutes at 60 rpm. A mass of mixed materials is obtained which is ready to acquire the shape that is given to it. The amount of water varies according to the climatological conditions in which the column is constructed; for example, in arid climates, 7 to 9 liters are required in order for the mixture to work properly, whereas only 3 to 4 liters of water are necessary in humid climates.
5.—Empty the mass from the previous step into a steel mold and place said steel mold onto a board which acts as a platform. At this point, three different molds are used to form the base, “body” and cap modules, respectively.
6.—Vibro-compact the mixture contained on the interior of the selected mold; for this purpose, the mold and its board are placed on a vibro-compaction machine. This operation is performed for at least 6 seconds in order to ensure that there is slump in the wetting of the mass, besides making it more consistent.
7.—Remove the mold and its board from the base of the vibro-compaction machine.
8.—Empty the previously selected block from the interior of the mold.
9.—Dry the block at room temperature for 36 hours.
10.—Hydrate the block in order to set it.
11.—Using a toothed chisel, chisel the outside surface of the block. This operation opens up its pores, giving it a rough appearance. In this manner, blocks are obtained that are symmetrical when joined together by means of their smaller vertical flat faces.

### Method for Installing a Modular Column.

Alternative 1.—Modular column anchored in the subsoil. (For loads.)
1.—Dig a hole in the location where the column is to be placed; the hole should be sufficiently deep as to be proportional to the dimensions of the column.
2.—Place a metallic profile (PTR) in the center of the hole in a vertical position. This will serve as a post and as the “core” of the modular column, providing it with solidity once the profile is fixed in its position around its faces.
3.—Fill the hole with the PTR on the interior with a mixture of conventional materials (cement, gravel, river sand and water), which drops and distributes itself on the metallic grate, thus anchoring the PTR;
4.—Allow the mixture filling to stand for at least 24 hours.
5.—Once the mixture filling is dry, the PTR remains perpendicular to the ground and is ready to receive the base, body and cap modules.
6.—Put the symmetrical blocks in place, joining them by means of their smaller vertical flat faces, thus forming a module.
7.—Using mixture, fill the square hollow which is formed as a result of the joining of the symmetrical blocks. Once the mixture has solidified, the blocks are firmly joined to the PTR as shown clearly in FIG. 2. Then:
8.—Stack one module on top of the other such that the lower horizontal surfaces of the symmetrical blocks are joined with the upper horizontal surfaces of other symmetrical blocks. This is continued until the desired height of the column is attained.

Alternative 2.—Modular column fixed to the ground. (Only for aesthetic purposes.) In this case, the mixture is poured inside the square hollow formed in the base module such that it makes contact with the ground and, upon hardening, said base module remains stuck on the ground.

Based on all of the foregoing, I state that the modular columns for construction purposes and method for the production thereof provide the following benefits: rapid construction, they are clean, economical and have versatile design characteristics.

1. Modular column for construction comprised of a base, a column body, a cap and a profile which is placed perpendicular to the ground, wherein the lower end of the profile is welded in perpendicular position at the base module which, upon making contact with the horizontal formed by the ground, supports all of the weight of the modular column on it, characterized in that it has “body” modules which are placed one on top of the other in overlapping fashion until the height of the column is established, and on the last “body” block is placed a cap module which is located on the upper end of the body of the column, said cap block optionally supporting a load or not if the modular column is only intended for aesthetic purposes, that it has a profile having reinforcements made of rebar rods that are placed in inclined fashion from the metallic grate to the body of the profile and used to reinforce the anchorage of the modular column from its base and a mixture of materials which is used to join blocks that are symmetrical in their profile.

2. Modular column for construction as set forth in claim 1, characterized in that its modules are optionally constructed from various regular and irregular prismatic bodies.

3. Modular column for construction as set forth in claim 1, characterized in that its symmetrical blocks are comprised of a mixture which is comprised of: 30% clay, 20% river sand, 30% pumice gravel [jal], 10% red volcanic rock [tezontle], 3% pigment, 5% talc and 2% Siamil slurry.

4. Modular column for construction, characterized in that one of its modules is comprised of two symmetrical blocks, one of which has:
a) two flat horizontal faces, one lower and one upper, the first making contact with the surface of the ground and second serving as a platform so that the lower face of the first of the series of modules can rest on same, and the upper faces are placed successively on the lower faces to form the “body” and cap of the modular column;
b) a vertical flat face which has located in its center a rectangular recess which results in the formation of two smaller vertical flat faces used to make contact with the two respective vertical flat faces of the symmetrical block, thus forming a module. On the other hand, the rectangular recesses of each block and its symmetry form a square hollow that is filled with mixture which, once solid, joins them; in addition, the profile is introduced in a vertical position in the center of said square hollow;
c) at least one design face which is also considered to be the front face of each symmetrical block, said face being able to adopt various geometrical shapes of regular and irregular polygons, in addition to which semiprecious stones can optionally be adhered to the surface or surfaces that are formed on the design face, or predetermined images can be engraved on same.

5. Modular column for construction, characterized in that it has the following series of symmetrical blocks:
a) “sectional” type blocks whose design face has three semi-cylindrical projections, one central and two lateral projections, which are perpendicular to the horizontal flat faces, where each one of the two latter ones meets at each end of its vertical flat face;
b) pentagonal blocks which, once joined, form hexagonal modules. Each design face of these blocks has two inclined flat surfaces which form four of the faces of the hexagonal module, since, once the lateral faces of each symmetrical block are joined, they form the two remaining faces to form said hexagonal module;
c) blocks with triangular recess for forming square modules which, when combined, form a vertical row of diamonds; for this purpose, the modules are placed such that the bases of the triangular recesses are made to coincide. The design face of these blocks has cylindrical bodies integrated into it which have a V-shaped recess on each side which, once in the column, appear as a pair of grooves that run the length of the body of the column; and
d) “horn”-type blocks for the column base whose design face has square corners.

6. Method for manufacturing the modular columns for constructions, characterized in that it comprises the following steps:
a) Pour the mixture of materials according to claim 3 into a mixer;
b) Dry-mix the mixture from the previous step in a mixer for 2 to 3 minutes at 60 ram until a homogeneous mixture is obtained;
c) Add to the moving mixture the equivalent of 33% of the total mixture of gray cement and continue to mix for 1.5 minutes at 60 rpm until homogenized;
d) Add 4 to 6 liters of water to the total mixture for the purpose of moistening it and continue mixing for 3 minutes at 60 rpm. A mass of mixed materials is obtained which is ready to acquire the shape that is given to it;
e) Empty the mass from the previous step into a steel mold and place said steel mold onto a board which acts as a platform. At this point, three different molds are used to form the base, “body” and cap modules, respectively;
f) Vibro-compact the mixture contained on the interior of the selected mold; for this purpose, the mold and its board are placed on a vibro-compaction machine; this operation is performed for at least 6 seconds in order to ensure that there is slump in the wetting of the mass, besides making it more consistent;
g) Remove the mold and its board from the base of the vibro-compaction machine;
h) Empty the previously selected block from the interior of the mold;
i) Dry the block at room temperature for 36 hours;
j) Hydrate the block in order to set it;
k) Using a toothed chisel, chisel the outside surface of the block; this operation opens up the pores, giving it a rough appearance. In this manner, blocks are obtained that are symmetrical when joined together by means of their smaller vertical flat faces.
